(19) United States
(12) Patent Application Publication
(10) Pub. No.: US 2025/0385347 A1
(43) Pub. Date: Dec. 18, 2025

(54) GRID-LIKE PATTERN SEALING DEVICE AND POUCH-TYPE BATTERY MANUFACTURED USING THE SAME

(71) Applicant: REPUBLIC OF KOREA (NATIONAL FORENSIC SERVICE DIRECTOR MINISTRY OF THE INTERIOR AND SAFETY), Wonju-si (KR)

(72) Inventors: Hyun Won LEE, Daejeon (KR); Young Su KONG, Gwangju (KR); Seung Woo WOO, Wonju-si (KR); Jung Woo NAM, Yongin-si (KR)

(21) Appl. No.: 19/233,119

(22) Filed: Jun. 10, 2025

(30) Foreign Application Priority Data
Jun. 17, 2024 (KR) 10-2024-0078232

(51) Int. Cl. H01M 50/105

(52) U.S. Cl. CPC H01M 50/105

(57) ABSTRACT

A grid-like pattern sealing device for sealing an electrode assembly by applying pressure to a pouch of a pouch-type battery according to an embodiment includes: a first sealing tool including a first pressure surface that is in close contact with a first sheet of the pouch; and a second sealing tool including a second pressure surface that is in close contact with a second sheet of the pouch, wherein the first pressure surface has a plurality of first convex portions, a plurality of second convex portions, and a plurality of first concave portions formed between the plurality of first convex portions and the plurality of second convex portions, the second pressure surface has a plurality of third convex portions, a plurality of fourth convex portions, and a plurality of second concave portions formed between the plurality of third convex portions and the plurality of fourth convex portions.

### CROSS-REFERENCE TO RELATED APPLICATIONS

The present application is based on and claims priority to Korean Patent Application No. 10-2024-0078232, filed on Jun. 17, 2024, in the Korean Intellectual Property Office, which is incorporated herein by reference in its entirety.

### BACKGROUND

### 1. Field

One or more embodiments relate to a grid-like pattern sealing device and a pouch-type battery manufactured using the same.

### 2. Description of the Related Art

The importance of secondary batteries, which are used as a key component for energy supply in electric vehicles (EVs), mobile phones, wearable devices, and portable PCs, is increasing. Among secondary batteries capable of charging and discharging, the use of lithium secondary batteries, which have excellent energy density characteristics, is increasing.

Lithium secondary batteries are classified into cylindrical, square, and pouch-type batteries depending on the outer material.

The utilization of pouch-type batteries is increasing because they have high energy density and can be custom-made in various sizes. In a pouch-type battery, the electrolyte inside the battery decomposes and gas is generated due to various factors such as overcharging, overdischarging, manufacturing defects, physical damage, and exposure to high temperatures, which increases internal pressure.

Methods to prevent ignition of lithium secondary batteries include preventing short-circuiting of positive and negative electrodes and removing flammable substances such as electrolytes. In the case of cylindrical batteries, flammable substances are removed through a vent when ignition begins due to high-temperature exposure, etc. Unlike cylindrical batteries, pouch-type batteries do not have a separate vent system, which poses the risk of a chain explosion.

### SUMMARY

One or more embodiments include a grid-like pattern sealing device that prevents electrolyte leakage, blocks moisture and oxygen, and maintains adhesive strength in pouch-type batteries by modifying a pressure surface design.

In addition, one or more embodiments include a grid-like pattern sealing device that prevents chain explosions in advance by inducing an early venting effect more easily than conventional sealing methods when exposing pouch-type batteries to high temperatures, etc.

According to one or more embodiments, a grid-like pattern sealing device for sealing an electrode assembly by applying pressure to a pouch of a pouch-type battery includes: a first sealing tool including a first pressure surface that is in close contact with a first sheet of the pouch; and a second sealing tool including a second pressure surface that is in close contact with a second sheet of the pouch, wherein the first pressure surface has a plurality of first convex portions arranged in a first direction, a plurality of second convex portions arranged in a second direction, and a plurality of first concave portions formed between the plurality of first convex portions and the plurality of second convex portions, the second pressure surface has a plurality of third convex portions arranged in a first direction, a plurality of fourth convex portions arranged in a second direction, and a plurality of second concave portions formed between the plurality of third convex portions and the plurality of fourth convex portions, and the first convex portions and the third convex portions, the second convex portions and the fourth convex portions, and the first concave portions and the second concave portions face each other and apply pressure.

In an embodiment, an angle formed between the first direction and the second direction may be greater than 0 degrees and less than or equal to 90 degrees.

In an embodiment, cross-sectional shapes of the first pressure surface of the first sealing tool and the second pressure surface of the second sealing tool may form mutual symmetry.

In an embodiment, at least one of the first sealing tool and the second sealing tool may include a heating element inside.

In an embodiment, the first sealing tool and the second sealing tool may further include a temperature sensor, and may further include a temperature control unit that controls a temperature of the heating element according to a measured value of the temperature sensor.

According to one or more embodiments, a pouch-type battery includes: an electrode assembly including a positive electrode, a separator, and a negative electrode; and a pouch including a first sheet and a second sheet covering one side and the other side of the electrode assembly, wherein the pouch includes a sealing portion formed by applying heat and pressure to an outer periphery of an area where the electrode assembly is arranged, wherein the sealing portion includes a plurality of sealing areas where the first sheet and the second sheet are completely sealed and a plurality of non-sealing areas where the first sheet and the second sheet are not sealed, wherein the plurality of sealing areas are arranged in a first direction and a second direction, and the non-sealing area is arranged between a first sealing area in the first direction and a second sealing area in the second direction.

In an embodiment, an angle formed between the first direction and the second direction may be greater than 0 degrees and less than or equal to 90 degrees.

In an embodiment, when internal pressure of the pouch-type battery increases, the sealing portion may induce an early venting effect by the non-sealing area.

In an embodiment, a total length in a width direction formed by the sealing area and the non-sealing area may be 2 mm to 10 mm.

Additional aspects will be set forth in part in the description which follows and, in part, will be apparent from the description, or may be learned by practice of the embodiments.

### BRIEF DESCRIPTION OF THE DRAWINGS

These and/or other aspects will become apparent and more readily appreciated from the following description of the embodiments, taken in conjunction with the accompanying drawings in which:

FIG. 1 is an exemplary view of a pouch-type battery and a grid-like pattern sealing device according to an embodiment;

FIG. 2 is a view of a sealing portion before and after a grid-like pattern sealing device operates according to an embodiment; and

FIGS. 3A and 3B are views illustrating various shapes of a sealing portion formed using a grid-like pattern sealing device according to an embodiment.

### DETAILED DESCRIPTION

Hereinafter, embodiments will be described in detail with reference to the accompanying drawings. The same reference numerals are used to denote the same elements, and repeated descriptions thereof will be omitted.

It will be understood that although the terms “first,” “second,” etc. may be used herein to describe various components, these components should not be limited by these terms.

An expression used in the singular encompasses the expression of the plural, unless it has a clearly different meaning in the context.

It will be further understood that the terms “comprises” and/or “comprising” used herein specify the presence of stated features or components, but do not preclude the presence or addition of one or more other features or components.

It will be understood that when a layer, area, or component is referred to as being “formed on” another layer, area, or component, it can be directly or indirectly formed on the other layer, area, or component. That is, for example, intervening layers, areas, or components may be present.

Sizes of components in the drawings may be exaggerated for convenience of explanation. In other words, since sizes and thicknesses of components in the drawings are arbitrarily illustrated for convenience of explanation, the following embodiments are not limited thereto.

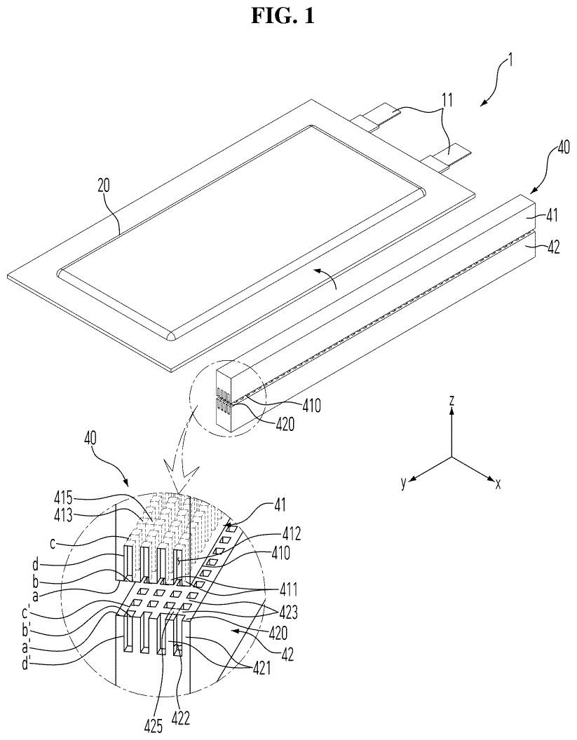

Hereinafter, a grid-like pattern sealing device according to an embodiment will be described with reference to FIGS. 1 to 3B.

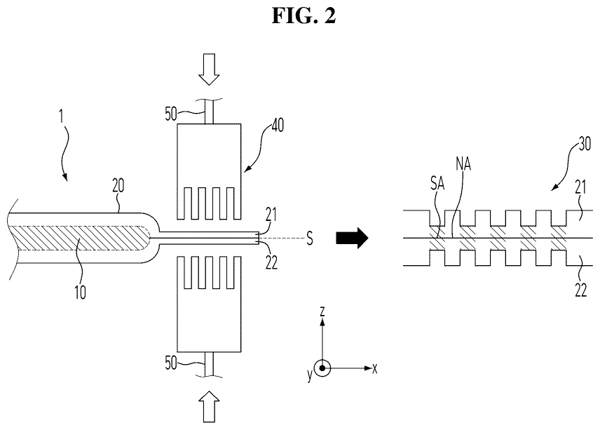

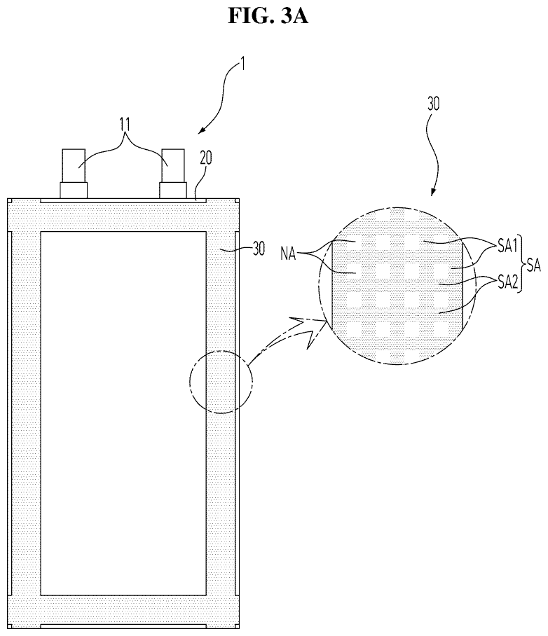

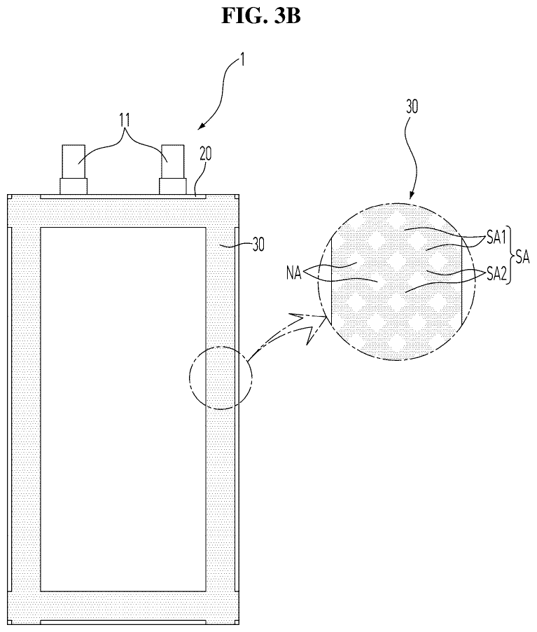

FIG. 1 is an exemplary view of a pouch-type battery and a grid-like pattern sealing device according to an embodiment, and FIG. 2 is a view of a sealing portion before and after a grid-like pattern sealing device operates according to an embodiment. FIGS. 3A and 3B are views illustrating various shapes of a sealing portion formed using a grid-like pattern sealing device according to an embodiment.

Referring to FIG. 1, a pouch-type battery 1 may include an electrode assembly 10 and a pouch 20 covering the electrode assembly 10.

The electrode assembly 10 is formed in a rolled form by stacking a positive electrode, a negative electrode, and a separator. Electrode tabs 11 may be drawn out from the positive electrode and the negative electrode.

The pouch 20 may include a first sheet 21 covering one side of the electrode assembly 10 and a second sheet 22 covering the other side of the electrode assembly 10. The first sheet 21 and the second sheet 22 may be separate members separated from each other, but may be formed as one sheet. For example, one sheet may be folded to cover both sides of the electrode assembly 10.

For example, the pouch 20 may include a resin layer, a metal layer, and an insulating layer.

The resin layer may be formed of polypropylene (PP) or casted polypropylene (CPP). The metal layer may be formed of steel series, aluminum, etc. to maintain mechanical strength of the pouch 20. The insulating layer may be formed of nylon or polyethylene-terephthalate (PET).

A sealing portion 30 is a portion formed on the pouch 20 by covering the electrode assembly 10 with the pouch 20 and applying heat and pressure to an outer periphery of an area where the electrode assembly 10 is disposed in the pouch 20.

The sealing portion 30 according to an embodiment will be described in detail after the grid-like pattern sealing device 40 is described.

Referring to FIGS. 1 and 2, the grid-like pattern sealing device 40 according to an embodiment may include a first sealing tool 41 and a second sealing tool 42.

The first sealing tool 41 may include a first pressure surface 410 that is in close contact with the first sheet 21 of the pouch 20. For example, referring to the drawings, the first sealing tool 41 may apply certain pressure to an upper side of the first sheet 21. At this time, a portion that is in close contact with the first sheet 21 is the first pressure surface 410 of the first sealing tool 41.

The first pressure surface 410 may include a plurality of first convex portions 411, a plurality of second convex portions 413, and a plurality of first concave portions 412. In the first pressure surface 410, the plurality of first convex portions 411 may be arranged in a first direction (y direction), and the plurality of second convex portions 413 may be arranged in a second direction (x direction). The plurality of first concave portions 412 may be formed between the plurality of first convex portions 411 and the plurality of second convex portions 413.

The first direction and the second direction may intersect to form two angles, and the smaller of the two angles may be greater than 0 degrees and less than or equal to 90 degrees.

A total length of a width formed by the first convex portions 411, the second convex portions 413, and the first concave portions 412 of the first sealing tool 41 may be equal to or longer than a length of a width formed by the sealing portion 30 of the pouch-type battery 1. A length of the first sealing tool 41 in a longitudinal direction may be about several to several tens of cm.

For example, a width a of a first convex portion 411 perpendicular to the first direction may be about 100 μm to 1000 μm. A width c of a second convex portion 413 perpendicular to the second direction may be about 100 μm to 1 cm. A gap b between the first convex portion 411 and the second convex portion 413 may be about 100 μm to 1000 μm. A depth d formed by a first concave portion 412 from the first convex portion 411 or the second convex portion 413 may be 1 mm or more. A first overlapping area 415 may be formed where the first convex portion 411 and the second convex portion 413 overlap.

When a length direction of the pouch 20 and the first direction coincide, and a width direction of the pouch 20 and the second direction coincide, such that the first direction and the second direction are perpendicular, the number of first convex portions 411 formed is not limited, but preferably ranges from 5 to 10. By providing a certain number of first convex portions 411, the problem of external moisture or oxygen penetration into the sealing portion 30 of the pouch-type battery 1 may be alleviated.

When the first direction and the second direction are perpendicular, the plurality of first convex portions 411 and the plurality of first concave portions 412 may be alternately arranged to form a cross section of a square wave.

The second sealing tool 42 may include a second pressure surface 420 that is in close contact with the second sheet 22 of the pouch 20. For example, referring to the drawings, the second sealing tool 42 may be positioned opposite the first sealing tool 41 such that it is in close contact with the second sheet 22 of the pouch 20.

At this time, a portion that is in close contact with the second sheet 22 is the second pressure surface 420 of the second sealing tool 42.

The second pressure surface 420 may include a plurality of third convex portions 421, a plurality of fourth convex portions 423, and a plurality of second concave portions 422. In the second pressure surface 420, the plurality of third convex portions 421 may be arranged in the first direction, and the plurality of fourth convex portions 423 may be arranged in the second direction. The plurality of second concave portions 422 may be formed between the plurality of third convex portions 421 and the plurality of fourth convex portions 423.

At this time, the first direction and the second direction may intersect to form two angles, and the smaller of the two angles may be greater than 0 degrees and less than or equal to 90 degrees.

A total length of a width formed by the third convex portions 421, the fourth convex portions 423, and the second concave portions 422 of the second sealing tool 42 may be equal to or longer than a length of a width formed by the sealing portion 30 of the pouch-type battery 1. A length of the second sealing tool 42 in a longitudinal direction may be about several to several tens of cm.

For example, a width a′ of a third convex portion 421 perpendicular to the first direction may be about 100 μm to 1000 μm. A width c′ of a fourth convex portion 423 perpendicular to the second direction may be about 100 μm to 1 cm. A gap b′ between the third convex portion 421 and the fourth convex portion 423 may be about 100 μm to 1000 μm. A depth d′ formed by a second concave portion 422 from the third convex portion 421 or the fourth convex portion 423 may be 1 mm or more. A second overlapping area 425 may be formed where the third convex portion 421 and the fourth convex portion 423 overlap.

When a length direction of the pouch 20 and the first direction coincide, and a width direction of the pouch 20 and the second direction coincide, such that the first direction and the second direction are perpendicular, the number of third convex portions 421 formed is not limited, but preferably ranges from 5 to 10. By providing a certain number of third convex portions 421, the problem of external moisture or oxygen penetration into the sealing portion 30 of the pouch-type battery 1 may be alleviated.

When the first direction and the second direction are perpendicular, the plurality of third convex portions 421 and the plurality of second concave portions 422 may be alternately arranged to form a cross section of a square wave.

A length a′ of the third convex portion 421 may be about 100 μm to 1000 μm, a gap b′ between the third convex portions 421 may be about 100 μm to 1000 μm, and a length d′ formed from the third convex portion 421 to the second concave portion 422 may be 1 mm or more.

The plurality of third convex portions 421 and the plurality of second concave portions 422 may be alternately arranged to form a cross-section of a square wave.

In addition, cross-sectional shapes of the first pressure surface 410 of the first sealing tool 41 and the second pressure surface 420 of the second sealing tool 42 may form mutual symmetry. For example, the first pressure surface 410 and the second pressure surface 420 of the grid-like pattern sealing device 40 may be symmetrically positioned with respect to the sealing surface S, where the first sheet 21 and the second sheet 22 are sealed.

In the grid-like pattern sealing device 40 according to an embodiment, the first convex portion 411 and the third convex portion 421, the second convex portion 413 and the fourth convex portion 423, and the first concave portion 412 and the second concave portion 422 may face each other and apply pressure.

An operating unit may apply pressure by moving the first sealing tool 41 or the second sealing tool 42. The operating unit may apply pressure by pressing the first sealing tool 41 against the first sheet 21 or by pressing the second sealing tool 42 against the second sheet 22.

For example, the operating unit may apply pressure through a moving unit 50 connected to one side of either the first sealing tool 41 or the second sealing tool 42, thereby bringing the first pressure surface 410 and the second pressure surface 420 into closer contact with the first sheet 21 and the second sheet 22 of the pouch 20.

The grid-like pattern sealing device 40 according to an embodiment may be formed to seal at least one side of the pouch-type battery 1. In general, the pouch-type battery 1 is rectangular in shape and has four sides. For example, each of the first sealing tool 41 and the second sealing tool 42 may be formed in a rectangular box shape to seal only one side of the pouch-type battery 1 with the grid-like pattern sealing device 40. In addition, the grid-like pattern sealing device 40 may be formed in a three-dimensional structure in which rectangular box-shaped elements are arranged to contact one side of the pouch-type battery 1, thereby enabling simultaneous sealing of two or more sides.

At this time, in the grid-like pattern sealing device 40, the first convex portion 411 and the third convex portion 421, the second convex portion 413 and the fourth convex portion 423, and the first concave portion 412 and the second concave portion 422 may face each other and apply pressure. Therefore, in the sealing portion 30 of the pouch-type battery 1, a portion of the pouch 20 to which the first convex portion 411, the second convex portion 413, the third convex portion 421, and the fourth convex portion 423 of the grid-like pattern sealing device 40 apply pressure is formed as a sealing area SA that is completely sealed. Meanwhile, a portion of the pouch 20 where the first concave portion 412 and the second concave portion 422 face each other may be formed as a non-sealing area NA that contains air therein.

Therefore, the sealing portion 30 of the pouch-type battery 1 may be formed by alternately arranging a plurality of sealing areas SA and non-sealing areas NA.

When cross-sectional shapes of the first pressure surface 410 of the first sealing tool 41 and the second pressure surface 420 of the second sealing tool 42 are mutually symmetrical, and the first concave portion 412 and the second concave portion 422 each form a rectangular cross-section, the volume of air that can be included in the non-sealing area NA of the sealing portion 30 may be maximized.

A sealing device of a general pouch-type battery completely seals the pouch 20 and the electrode assembly 10 by applying an appropriate amount of pressure during a sealing process. In general, a pressure range of the sealing device may be 0.1 MPa to 2 MPa. There are differences depending on the size and design of the pouch-type battery, the material of a pouch, and other characteristics.

Applying an appropriate amount of pressure may maximize the sealing performance of the pouch-type battery and contribute to improved stability and longer lifespan.

A sealing temperature works in conjunction with pressure to optimize a sealing effect, and is typically between 150° C. and 250° C.

In addition, at least one of the first sealing tool 41 and the second sealing tool 42 may include a heating element inside. For example, a heating element used may include a cartridge heater, a sheath heater, a hot wire heater, etc. The heating element may be selected by considering required temperature distribution, heating speed, temperature control precision, etc.

The first sealing tool 41 and the second sealing tool 42 may further include a temperature sensor. The grid-like pattern sealing device 40 may further include a temperature control unit that controls a temperature of the heating element according to a measured value of the temperature sensor.

For example, the temperature sensor may be a resistance temperature detector (RTD), a thermocouple, a thermistor, etc. Temperature data measured by the temperature sensor is transmitted to the temperature control unit, and a measured temperature can be controlled to be maintained within a preset temperature range. Temperature control has a direct effect on sealing quality. When the temperature is too low, heat fusion of the pouch material may be incomplete, leading to reduced sealing strength. On the other hand, excessively high temperatures may cause the pouch material to melt or deform. In this way, a temperature can be monitored and controlled within a certain range through feedback, which contributes to achieving uniform sealing strength.

In addition, a sealing time of several seconds to several tens of seconds can be secured while maintaining appropriate pressure and temperature.

The grid-like pattern sealing device 40 according to an embodiment may perform a sealing process under pressure or temperature similar to that of the existing sealing device as described above. In addition, identical pressure and temperature may be transmitted to the first convex portions 411, the second convex portions 413, the third convex portions 421, and the fourth convex portions 423 of the grid-like pattern sealing device 40, respectively. Therefore, the grid-like pattern sealing device 40 reduces the sealing area SA by employing different shapes in the first and second pressure surfaces 410 and 420, thereby enabling sealing under conventional sealing conditions while achieving a venting effect.

Furthermore, the grid-like pattern sealing device 40 according to an embodiment may be composed of a material generally used in sealing devices. The material of the grid-like pattern sealing device 40 is not limited to a specific material, but it needs to be able to withstand high temperatures and be durable.

For example, the material of the grid-like pattern sealing device 40 may include stainless steel, aluminum, titanium, nickel-plated material, and ceramic coatings.

Because the grid-like pattern sealing device 40 according to an embodiment has a complex shape, it is preferable to use aluminum or an aluminum alloy. This is because aluminum has a lower melting point (660° C.) than iron (melting point 1530° C.) and is malleable and ductile, so it can be molded into desired shapes using various techniques, allowing for the manufacture of complex shapes.

The sealing portion 30 of the pouch-type battery 1 manufactured by the grid-like pattern sealing device 40 according to an embodiment may be formed by applying heat and pressure to an outer periphery of an area where the electrode assembly 10 is arranged in the pouch 20. In the sealing portion 30, the sealing areas SA where the first sheet 21 and the second sheet 22 are completely sealed and the non-sealing area NA where the first sheet 21 and the second sheet 22 are not sealed may be alternately arranged.

The first sealing surface 410 and the second sealing surface 420, which face each other in the grid-like pattern sealing device 40, may be pressed against the first sheet 21 and the second sheet 22 of the pouch 20, respectively, to form the sealing portion 30. When the first convex portion 411 and the third convex portion 421, and the second convex portion 413 and the fourth convex portion 423 of the grid-like pattern sealing device 40 are each pressed against the pouch 20, the pouch 20 may be completely sealed to form the sealing area SA of the sealing portion 30. The first concave portion 412 and the second concave portion 422 may form the non-sealing area NA of the sealing portion 30 that is not completely sealed and includes air.

The plurality of sealing areas SA may be arranged in the first direction and the second direction, and the non-sealing areas NA may be arranged between a first sealing area SA1 in the first direction and a second sealing area SA2 in the second direction. Therefore, the plurality of sealing areas SA and the plurality of non-sealing areas NA may form a grid-like pattern.

The first direction and the second direction may intersect to form two angles, and the smaller of the two angles may be greater than 0 degrees and less than or equal to 90 degrees.

When internal pressure of the pouch-type battery 1 increases due to high temperature, etc., the sealing portion 30 may induce an early venting effect by the non- sealing area NA. That is, when the internal pressure of the pouch-type battery 1 increases, the non-sealing area NA is preferentially opened, thereby generating a venting effect.

The sealing portion 30 may be formed to seal at least one side of the pouch-type battery 1. For example, the sealing portion 30 may be formed to seal only one side of the pouch-type battery 1, or may be formed to seal two or more sides.

A total length in a width direction formed by the sealing area SA and the non-sealing area NA of the sealing portion 30 may be 2 mm to 10 mm. For example, a width direction length of the sealing portion 30 may be 2 mm to 3 mm for small batteries, and 10 mm or less for medium and large batteries. The width direction length of the sealing portion 30 may be formed to be equal to or shorter than a total width length formed by the first convex portion 411 (or the third convex portion 421), the second convex portion 413 (or the fourth convex portion 423), and the first concave portion 412 (or the second concave portion 422) in the grid-like pattern sealing device 40.

A width of the first sealing area SA1 and the second sealing area SA2 may be approximately 100 μm to 1000 μm, and a width of the non-sealing area NA may be approximately 100 μm to 1000 μm.

Therefore, the grid-like pattern sealing device 40 forms non-sealing areas NA in the sealing portion 30, which open when internal pressure increases, enabling early venting to remove flammable gases and prevent chain explosions.

In addition, the grid-like pattern sealing device 40 according to an embodiment may be designed in a different form from the existing sealing device and perform a sealing process by applying temperature and pressure conditions similar to those used in conventional processes, thereby generating a venting effect in the pouch-type battery 1.

Furthermore, the sealing portion 30 of the pouch-type battery 1 formed using the grid-like pattern sealing device 40 according to an embodiment may prevent electrolyte leakage, block moisture and oxygen, and maintain adhesive strength.

It should be understood that embodiments described herein should be considered in a descriptive sense only and not for purposes of limitation. Descriptions of features or aspects within each embodiment should typically be considered as available for other similar features or aspects in other embodiments. Therefore, the scope of the disclosure is defined by the appended claims.

What is claimed is:

1. A grid-like pattern sealing device for sealing an electrode assembly by applying pressure to a pouch of a pouch-type battery, the grid-like pattern sealing device comprising:
a first sealing tool including a first pressure surface that is in close contact with a first sheet of the pouch; and
a second sealing tool including a second pressure surface that is in close contact with a second sheet of the pouch,
wherein the first pressure surface has a plurality of first convex portions arranged in a first direction, a plurality of second convex portions arranged in a second direction, and a plurality of first concave portions formed between the plurality of first convex portions and the plurality of second convex portions,
the second pressure surface has a plurality of third convex portions arranged in a first direction, a plurality of fourth convex portions arranged in a second direction, and a plurality of second concave portions formed between the plurality of third convex portions and the plurality of fourth convex portions, and
the first convex portions and the third convex portions, the second convex portions and the fourth convex portions, and the first concave portions and the second concave portions face each other and apply pressure.

2. The grid-like pattern sealing device of claim 1, wherein an angle formed between the first direction and the second direction is greater than 0 degrees and less than or equal to 90 degrees.

3. The grid-like pattern sealing device of claim 1, wherein cross-sectional shapes of the first pressure surface of the first sealing tool and the second pressure surface of the second sealing tool form mutual symmetry.

4. The grid-like pattern sealing device of claim 1, wherein at least one of the first sealing tool and the second sealing tool includes a heating element inside.

5. The grid-like pattern sealing device of claim 4, wherein the first sealing tool and the second sealing tool further comprise a temperature sensor, and further comprise a temperature control unit that controls a temperature of the heating element according to a measured value of the temperature sensor.

6. A pouch-type battery comprising:
an electrode assembly including a positive electrode, a separator, and a negative electrode; and
a pouch including a first sheet and a second sheet covering one side and the other side of the electrode assembly,
wherein the pouch comprises a sealing portion formed by applying heat and pressure to an outer periphery of an area where the electrode assembly is arranged,
wherein the sealing portion comprises a plurality of sealing areas where the first sheet and the second sheet are completely sealed and a plurality of non-sealing areas where the first sheet and the second sheet are not sealed, wherein the plurality of sealing areas are arranged in a first direction and a second direction, and the non-sealing area is arranged between a first sealing area in the first direction and a second sealing area in the second direction.

7. The pouch-type battery of claim 6, wherein an angle formed between the first direction and the second direction is greater than 0 degrees and less than or equal to 90 degrees.

8. The pouch-type battery of claim 6, wherein, when internal pressure of the pouch-type battery increases, the sealing portion induces an early venting effect by the non-sealing area.

9. The pouch-type battery of claim 6, wherein a total length in a width direction formed by the sealing area and the non-sealing area is 2 mm to 10 mm.
